(19) United States
(12) Patent Application Publication
(10) Pub. No.: US 2005/0139612 A1
(43) Pub. Date: Jun. 30, 2005

(54) Foam dispenser

(76) Inventors: Shaun Kerry Matthews, Oswestry (GB); David Michael Ross Creaghan, Hamilton (CA)

Correspondence Address: Ralph A. Dowell of DOWELL & DOWELL P.C., 2111 Eisenhower Ave., Suite 406, Alexandria, VA, 22314, US

(21) Appl. No.: 10/747,627

(22) Filed: Dec. 30, 2003

(51) Int. Cl. B67D 5/58

(52) U.S. Cl. 222/190

(57) ABSTRACT

A foam dispenser is for use with a container containing soap or other liquid. The device includes a rotary soap pump, a rotary air pump, a mixing chamber, a porous membrane and an actuator or driver. The rotary soap pump has a soap inlet and a soap outlet and the soap inlet is operably connectable to the container. The rotary air pump has an air inlet and an air outlet. The mixing chamber is in flow communication with the air outlet and the soap outlet and the mixing chamber has an outlet. The porous membrane is positioned such that an air and soap mixture that passes through the mixing chamber outlet passes through the porous membrane thereby producing foam. The actuator or driver is operably connected to the rotary soap pump and the rotary air pump.

### FIELD OF THE INVENTION

This invention relates to foam dispensers and in particular foam dispensers having a rotary drive mechanism.

### BACKGROUND OF THE INVENTION

Liquid dispensers for dispensing soap and the like are well known. There are a wide variety of liquid dispensers for use in association with liquid soap. Some of these dispense the soap or other liquid in the form of a foam. There are a number of advantages that are realized by dispensing in the form of foam. Specifically foam is easier to spread than the corresponding liquid. As well there is much less splashing or run-off since the foam has a much higher surface tension than the liquid. In addition, the foam requires much less liquid to produce the same cleansing power as compared to the un-foamed liquid due to the much higher surface area of the foam. Accordingly the cost to wash a specific number of hands is reduced since the amount of soap used is reduced. Similarly there are environmental benefits from using the foam since the amount of product used is reduced.

There are typically two types of foamers, one which uses a jet of air and another which mixes the liquid with air and then drives the combination through a porous material. The former type of foamer has the disadvantage that the quality of foam varies depending on the dispensing force. The latter design, although it works very well under most circumstances, has a number of characteristics that in certain circumstances are undesirable. For example it is difficult to adjust the ratio of air to liquid. Two example of the latter type of foamers are shown in U.S. Pat. No. 5,445,288 issued Aug. 29, 1995 and U.S. Pat. No. 6,082,586 issued Jul. 4, 2000 both issued to Banks. These foamers use a lever or pushbutton to activate the device. Another example of the latter type of foamer is shown in U.S. Pat. No. 5,037,006 issued Aug. 6, 1991 to Kock. This foamer is a squeeze operated foamer. All of these examples of foamers suffer from the limitation described above wherein ratio of air to liquid cannot be easily adjusted.

Accordingly it would be advantageous to provide a foam dispenser that has a consistent yet adjustable amount of discharge per shot. Further it would be advantageous to provide a foam dispenser wherein the ratio of the air to the liquid can be easily adjusted. Still further it would be advantageous to provide a foam dispenser that has a method of actuation that can easily be adapted to be used with a lever, a push button or an electrical motor.

### SUMMARY OF THE INVENTION

The present invention is a foam dispenser for use with a container containing soap or other liquid. The device includes a rotary soap pump, a rotary air pump, a mixing chamber, an aeration gauze and an actuator or driver. The rotary soap pump has a soap inlet and a soap outlet and the soap inlet is operably connectable to the container. The rotary air pump has an air inlet and an air outlet. The mixing chamber is in flow communication with the air outlet and the soap outlet and the mixing chamber has an outlet. The aeration gauze is positioned such that an air and soap mixture that passes through the mixing chamber outlet passes through the gauze thereby producing foam. The actuator or driver is operably connected to the rotary soap pump and the rotary air pump.

In another aspect of the invention the invention is a foam dispenser for producing and dispensing foam. The dispenser includes a container, a rotary soap pump, a rotary air pump, a mixing chamber, a porous membrane an actuator or driver and a housing. The container is for containing a liquid. The rotary soap pump has a soap inlet and a soap outlet and the soap inlet is operably connectable to the container. The rotary air pump has an air inlet and an air outlet. The mixing chamber is in flow communication with the air outlet and the soap outlet. The mixing chamber has an outlet. The porous membrane is positioned such that an air and soap mixture that passes through the mixing chamber outlet passes through the porous membrane thereby producing foam. The actuator or driver is operably connected to the rotary soap pump and the rotary air pump. The housing has an interior and the container, the soap pump, the air pump, the mixing chamber are housed within the housing interior.

Further features of the invention will be described or will become apparent in the course of the following detailed description.

### BRIEF DESCRIPTION OF THE DRAWINGS

The invention will now be described by way of example only, with reference to the accompanying drawings, in which:

FIG. 1 is a perspective view of a liquid dispenser constructed in accordance with the present invention;

FIG. 2 is a cross sectional view of a liquid dispenser of the present invention;

FIG. 3 is a cross sectional view of one embodiment of the rotary foam pump assembly of the present invention wherein the assembly includes a double lobe pump;

FIG. 4 is a cross sectional view of an alternate embodiment of the rotary foam pump assembly of the present invention wherein the assembly includes a double vane pump;

FIG. 5 is a cross sectional view of a third embodiment of the rotary foam pump assembly of the present invention wherein the assembly includes a double gear pump;

FIG. 6 is a cross sectional view of a fourth embodiment of the rotary foam pump assembly of the present invention wherein the assembly includes a double peristaltic pump.

### DETAILED DESCRIPTION OF THE INVENTION

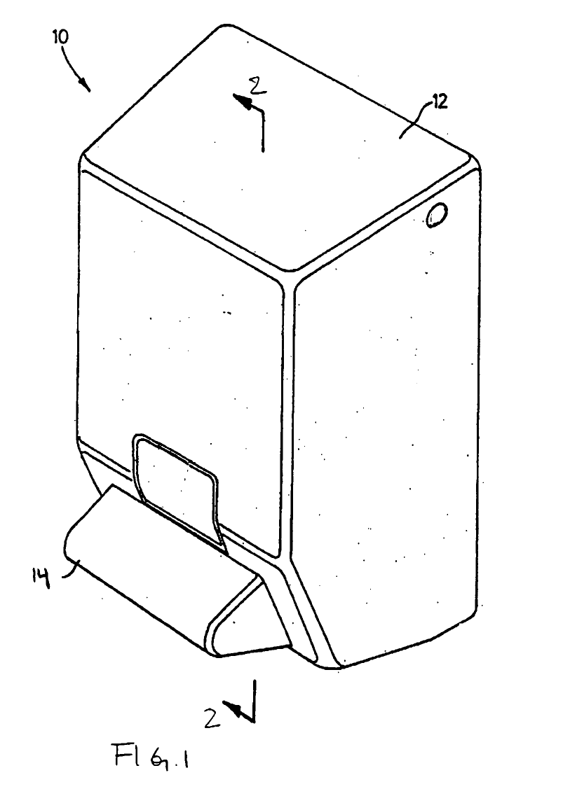

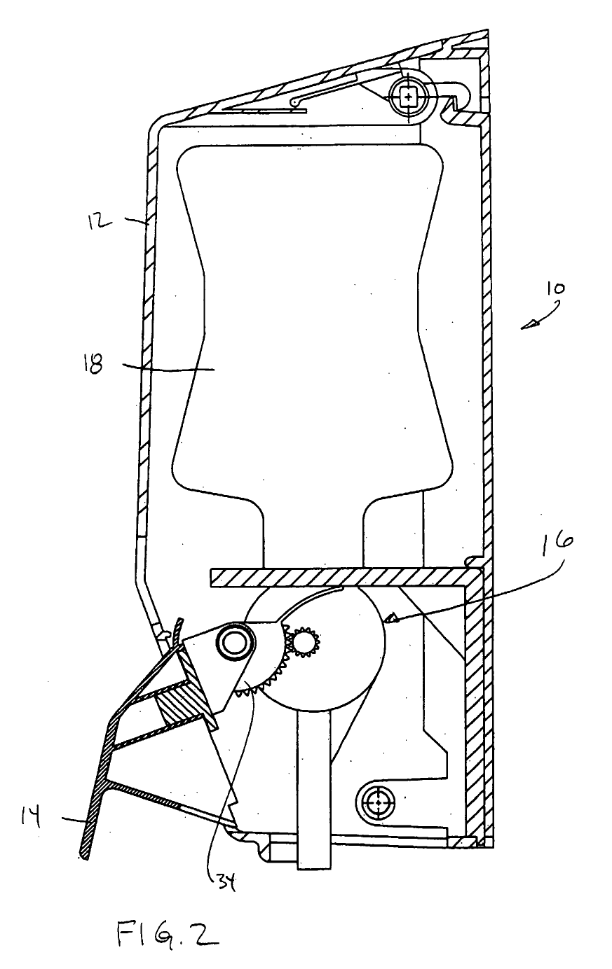

Referring to FIG. 1 and FIG. 2, a liquid dispenser containing a liquid container and pump is shown generally at 10. Dispenser 10 includes a housing 12 and a drive bar or lever 14. The lever 14 is operably connected to the rotary pump assembly 16 which is connected to a collapsible liquid container 18. The lever 14 is attached to a drive rack 34 which engages the pumps in the rotary pump assembly.

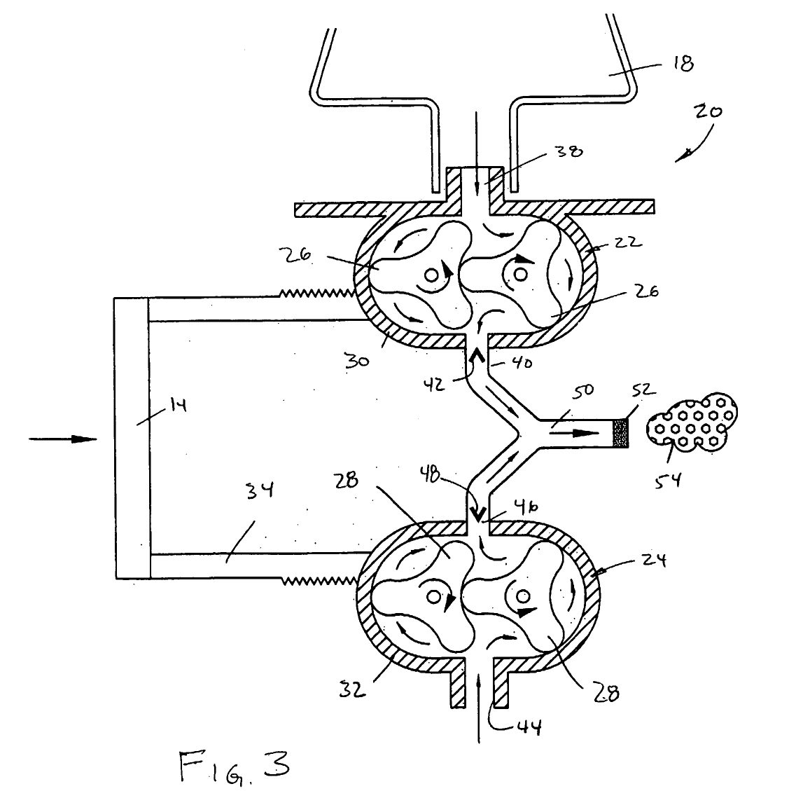

Referring to FIG. 3, the first embodiment of the rotary pump assembly is a double lobe pump and is shown generally at 20. Double lobe pump 20 includes a soap pump 22 and an air pump 24. The soap pump 22 and the air pump 24 each have a pair of intermeshing tri-lobes 26 and 28, respectively. Each pair of tri-lobes 26, 28 rotate in opposite directions. Each of the soap pump 22 and the air pump 24 have a soap pump housing 30 and an air pump housing 32, respectively. A drive rack 34 is connected to the drive bar or lever 14. The drive rack 34 is operably connected to the lobes 26 and 28. The drive rack 34 is biased in the rest position. The soap pump 22 has a soap inlet 38 and a soap outlet 40. A one way soap valve 42 is positioned in the soap outlet 40. The soap inlet 38 is in flow communication with the liquid inside the collapsible container 18. The air pump 24 has an air inlet 44 and an air outlet 46 with a one way air valve 48 positioned therein. The soap outlet 40 and the air outlet 46 are in flow connection with a mixing channel or chamber 50. The soap/air mixture passes through a porous membrane or aeration gauze 52 to produce foam 54.

In use, a user pushes the lever 14 which drives the drive rack 34 and causes the soap lobes 26 and the air lobes 28 to advance, thus moving soap from the soap inlet 38 to the soap outlet 40 and air from the air inlet 44 to the air outlet 46. The soap and the air mix in the mixing chamber 50 and the soap/air mixture is forced through the gauze 52 to produce foam 54.

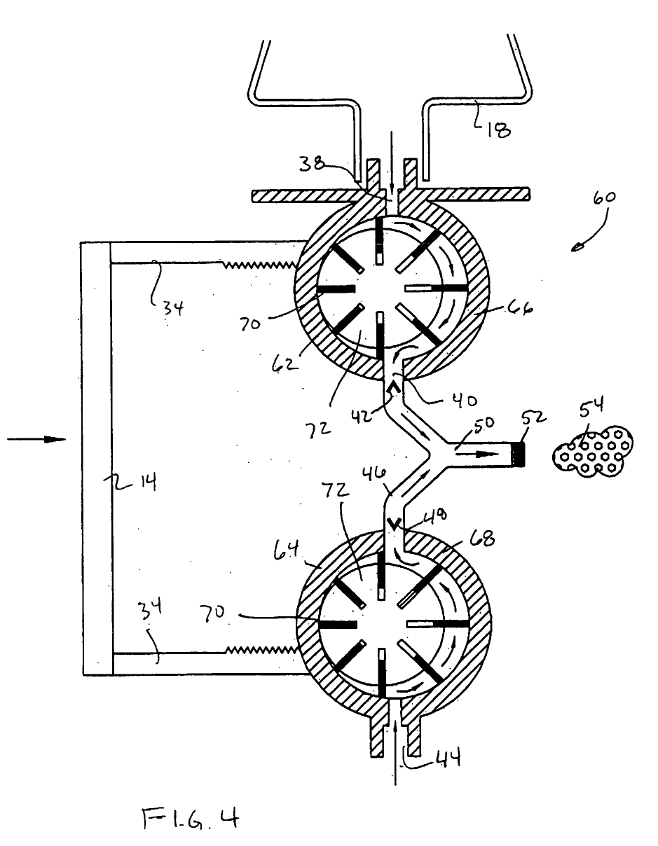

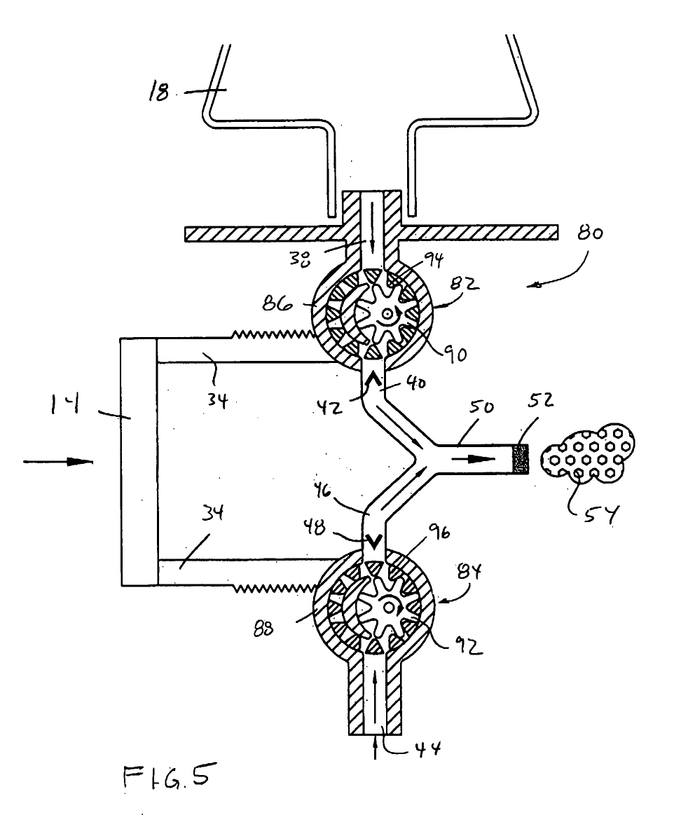

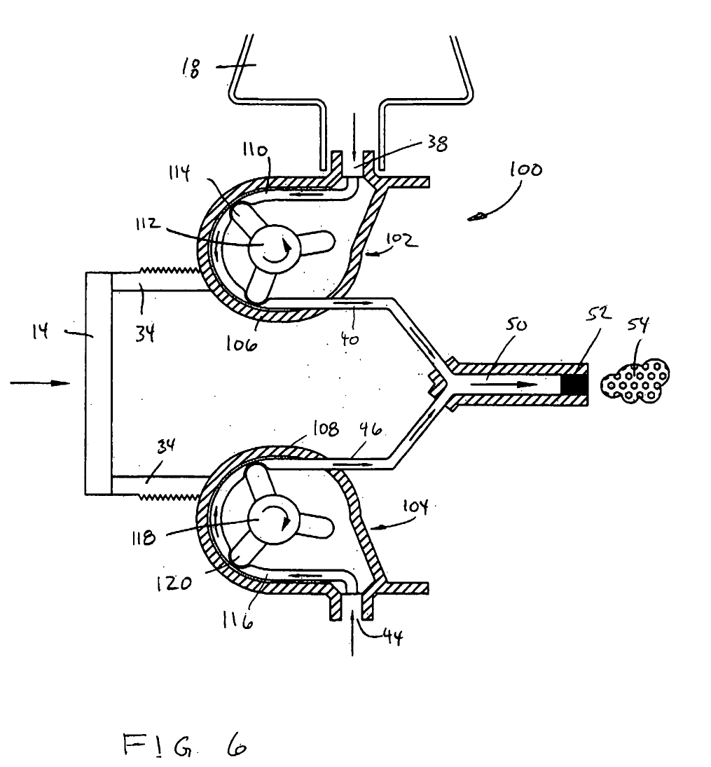

The above describes the basic concept of the rotary foam dispenser of the present invention. However it will be appreciated by those skilled in the art that there are a number of different rotary pumps that could also be used. For example a vane pump (FIG. 4), a gear pump (FIG. 5) or a peristaltic pump (FIG. 6). Each of which is described in more detail below. Only the features that are different from those described above will be discussed.

Referring to FIG. 4, a double vane pump is shown generally at 60. Double vane pump 60 includes a soap vane pump 62 and an air vane pump 64. Each of the soap pump 62 and the air pump 64 have a soap pump housing 66 and an air pump housing 68, respectively. Each vane pump has a plurality of vanes 70 extending outwardly from a rotatable drive wheel 72. The vanes 70 are evenly spaced around the rotatable drive wheel 72. A drive rack 34 is connected to the drive bar or lever 14. The drive rack 34 is operably connected to the rotatable drive wheels 72. The drive rack 34 is biased in the rest position. The soap pump 62 has a soap inlet 38 and a soap outlet 40. A one way soap valve 42 is positioned in the soap outlet 40. The soap inlet is in flow communication with the liquid inside the collapsible container 18. The air pump 64 has an air inlet 44 and an air outlet 46 with a one way air valve 48 positioned therein. The soap outlet 40 and the air outlet 46 are in flow connection with a mixing channel or chamber 50. The mixture passes through a porous membrane 52 to produce foam 54.

Referring to FIG. 5, a double gear pump is shown generally at 80. Double gear pump 80 includes a soap gear pump 82 and an air gear pump 84. Each of the soap pump 82 and the air pump 84 have a soap pump housing 86 and an air pump housing 88 respectively. The soap pump 82 and the air pump 84 each have a drive gear 90 and 92 and a pump gear 94 and 96 respectively and the drive gear is rotatable in the pump gear. A drive rack 34 is connected to the drive bar or lever 14. The drive rack 34 is operably connected to the drive gears 90 and 92. The drive rack 34 is biased in the rest position. The soap pump 82 has a soap inlet 38 and a soap outlet 40. A one way soap valve 42 is positioned in the soap outlet 40. The soap inlet 38 is in flow communication with the liquid inside the collapsible container 18. The air gear pump 84 has an air inlet 44 and an air outlet 46 with a one way air valve 48 positioned therein. The soap outlet 40 and the air outlet 46 are in flow connection with a mixing channel or chamber 50. The mixture passes through a porous membrane 52 to produce foam 54.

Referring to FIG. 6, a double peristaltic pump is shown generally at 100. Double peristaltic pump 100 includes a soap peristaltic pump 102 and an air peristaltic pump 104. Each of the soap pump 102 and the air pump 104 have a soap pump housing 106 and an air pump housing 108. The soap pump 102 has a flexible soap tube 110 around the inside periphery and a peristaltic drive wheel 112 with a plurality of paddles 114 are attached thereto. The paddles 114 engage the flexible soap tube 110 and move soap therethrough. Similarly the air pump 104 has a flexible air tube 116 and a peristaltic air drive wheel 118 with a plurality of paddles 120 attached thereto. A drive rack 34 is connected to the drive bar or lever 14. The drive rack 34 is operably connected to the soap drive wheel 112 and air drive wheel 118. The drive rack 34 is biased in the rest position. The soap pump 102 has a soap inlet 38 and a soap outlet 40 both in flow communication with the soap tube 110. The soap inlet 38 is in flow communication with the inside of the collapsible container 18. The air peristaltic pump 104 has an air inlet 44 and an air outlet 46, each in flow communication with the air tube 116. The soap outlet 40 and the air outlet 46 are in flow connection with a mixing channel or chamber 50. The mixture passes through a porous membrane 52 to produce foam 54.

It will be appreciated by those skilled in the art that the amount of air and soap can be easily adjusted by adjusting the stroke of the drive rack 34. Further the ratio between the air and the soap can be easily adjusted by adjusting the gear ratio between the lever and the soap drive wheel relative to the lever and the air drive wheel.

The dispenser shown herein could be further enhanced by including a motion detector to determine when an object is within a predetermined range and to activate the device. Further, it will be appreciated by those skilled in the art that although the dispenser is shown with a lever 14 as an actuation device there are a number of other methods of actuation that would also work. Specifically, by way of example, dispensing could also be actuated with a push button or a crank.

As used herein, the terms “comprises” and “comprising” are to be construed as being inclusive and opened rather than exclusive. Specifically, when used in this specification including the claims, the terms “comprises” and “comprising” and variations thereof mean that the specified features, steps or components are included. The terms are not to be interpreted to exclude the presence of other features, steps or components.

It will be appreciated that the above description related to the invention by way of example only. Many variations on the invention will be obvious to those skilled in the art and such obvious variations are within the scope of the invention as described herein whether or not expressly described.

1. A foam dispenser for use with a container containing soap or other liquid comprising:
a rotary soap pump having a soap inlet and a soap outlet wherein the inlet is operably connectable to the container,
a rotary air pump having an air inlet and an air outlet;
a mixing chamber in flow communication with the air outlet and the soap outlet, the mixing chamber having an outlet;
a porous membrane downstream of the mixing chamber, whereby an air and soap mixture that passes through the mixing chamber outlet passes through the porous membrane thereby producing foam; and
a drive means operably connected to the rotary soap pump and the rotary air pump.

2. A foam dispenser as claimed in claim 1 further including a one way valve positioned in the soap outlet.

3. A foam dispenser as claimed in claim 2 further including a one way valve positioned in the air outlet.

4. A foam dispenser as claimed in claim 3 wherein the container is a collapsible container and whereby the container collapses as liquid is pumped therefrom.

5. A foam dispenser as claimed in claim 1 wherein the soap pump and the air pump are each lobe pumps.

6. A foam dispenser as claimed in claim 5 wherein each lobe pump has a pair of intermeshing tri-lobes.

7. A foam dispenser as claimed in claim 1 wherein the soap pump and the air pump are each vane pumps.

8. A foam dispenser as claimed in claim 7 wherein each vane pump has a plurality of vanes spaced around a drive wheel.

9. A foam dispenser as claimed in claim 1 wherein the soap pump and the air pump are each gear pumps.

10. A foam dispenser as claimed in claim 9 wherein each gear pump has a drive gear and a pump gear and wherein the drive gear is rotatable in the pump gear.

11. A foam dispenser as claimed in claim 1 wherein the soap pump and the air pump are each peristaltic pumps.

12. A foam dispenser as claimed in claim 11 wherein each peristaltic pump has a flexible tube and a peristaltic drive wheel and the peristaltic drive wheel engages the flexible tube.

13. A rotary foam dispenser for producing and dispensing foam comprising:
a container for containing a liquid;
a rotary soap pump having a soap inlet and a soap outlet wherein the inlet is operably connectable to the container;
a rotary air pump having an air inlet and an air outlet;
a mixing chamber in flow communication with the air outlet and the soap outlet having an outlet;
a porous membrane downstream of the mixing chamber, whereby an air and soap mixture that passes through the mixing chamber outlet passes through the gauze thereby producing foam;
a drive means operably connected to the rotary soap pump and the rotary air pump; and
a housing having an interior and the container, the soap pump, the air pump, the mixing chamber are housed within the housing interior.

14. A rotary foam dispenser as claimed in claim 13 further including a one way valve positioned in the soap outlet.

15. A rotary foam dispenser as claimed in claim 14 further including a one way valve positioned in the air outlet.

16. A rotary foam dispenser as claimed in claim 15 wherein the container is a collapsible container and whereby the container collapses as liquid is pumped therefrom.

17. A rotary foam dispenser as claimed in claim 13 wherein the soap pump and the air pump are each lobe pumps.

18. A rotary foam dispenser as claimed in claim 17 wherein each lobe pump has a pair of intermeshing tri-lobes.

19. A rotary foam dispenser as claimed in claim 13 wherein the soap pump and the air pump are each vane pumps.

20. A rotary foam dispenser as claimed in claim 20 wherein each vane pump has a plurality of vanes spaced around a drive wheel.

21. A rotary foam dispenser as claimed in claim 13 wherein the soap pump and the air pump are each gear pumps.

22. A rotary foam dispenser as claimed in claim 21 wherein each gear pump has a drive gear and a pump gear and wherein the drive gear is rotatable in the pump gear.

23. A rotary foam dispenser as claimed in claim 13 wherein the soap pump and the air pump are each peristaltic pumps.

24. A rotary foam dispenser as claimed in claim 23 wherein each peristaltic pump has a flexible tube and a peristaltic drive wheel and the peristaltic drive wheel engages the flexible tube.
